(19) United States
(12) Patent Application Publication
(10) Pub. No.: US 2021/0260509 A1
(43) Pub. Date: Aug. 26, 2021

(54) DEVICE AND METHOD FOR FILTERING A FLUID CIRCULATING IN A PLUMBING AND HEATING SYSTEM

(71) Applicant: I.V.A.R. S.P.A., Prevalle (BS) (IT)

(72) Inventors: Umberto BERTOLOTTI, Prevalle (BS) (IT); Mario CONTINI, FLERO (BS) (IT)

(73) Assignee: I.V.A.R. S.P.A., Prevalle (BS) (IT)

(21) Appl. No.: 17/091,521

(22) PCT Filed: Apr. 30, 2019
(86) PCT No.: PCT/IB2019/053542

§ 371 Date: Nov. 6, 2020

(30) Foreign Application Priority Data
Jun. 6, 2018 (IT) 102018000006093

(51) Int. Cl. B01D 35/06; B01D 29/03; B01D 35/30; B03C 1/033; B03C 1/30; B01D 35/16; B03C 1/28

(52) U.S. Cl. CPC B01D 35/06; B01D 29/035; B01D 35/30; B03C 2201/18; B03C 1/30; B01D 35/16; B03C 1/286; B03C 1/0332

(57) ABSTRACT

The present invention relates to a device (1) for filtering a fluid circulating in a plumbing and heating system, said device comprising a body (2) which defines therewithin a filtration chamber (3) that is destined to have a fluid to be subjected to filtration pass through it. The body is provided with a first inlet/outlet opening (10), a second inlet/outlet opening (20) and a third inlet/outlet opening (30): each one of them sets the filtration chamber (3) in communication with the outside of the device and is associable with a line of the system so as to receive therefrom, or to send thereto, fluid entering, or exiting from, said body of the device. The device brings about a passage of fluid through the filtration chamber (3), in a selective manner according to a plurality of operative configurations, from one opening among said first (10), second (20) and third (30) inlet/outlet openings to another opening among said first, second and third inlet/outlet openings. The device further comprises filtering members (40) that are housed inside the filtration chamber and interposed between the inlet/outlet openings so as to carry out filtering of the fluid passing through the filtration chamber; the filtering members comprise a filtering septum (41) arranged in the filtration chamber so as to subdivide it into a first half-chamber (8) and a second half-chamber (9), wherein the first half-chamber is in fluid communication with the first inlet/outlet opening, without passage through the filtering septum, and the second half-chamber is in fluid communication with the second and the third inlet/outlet opening, without passage through the filtering septum.

The present invention relates to a device, and an associated method, for filtering a fluid circulating in a plumbing and heating system

The invention has advantageous application in the context of plumbing systems for temperature regulation and/or the supply of domestic hot water in residential, commercial or industrial buildings.

Heating or domestic hot water supply systems provide for the circulation of a fluid, typically water, which circulates through the various system components (pipes, boiler, pump, valves, radiant elements, utilities, etc.).

In such systems the use of filters suitable for maintaining the circulating fluid as clean as possible, i.e. free of impurities, such as dirt, sand, polluting particles, etc., is well known. This is because such impurities, while circulating within the system, can provoke clogging, faults in some components, in particular the boiler and the valves, and in general cause a deterioration in the performance of the various components and a loss of overall efficiency.

Among the various impurities, it is particularly important to remove the ferrous particles—typically released by system components such as pipes and radiant elements (for example heaters and radiators)—since they can cause breaks inside the boiler members or perforations in the pipes of the system.

The filters are usually installed interposed between the line carrying the fluid returning from the system, typically containing impurities and ferrous particles, and the line that sends the incoming fluid to the boiler (or heat pump). In this manner, the filter can act on the delivery to the boiler, that is, upstream of the latter, by sending fluid that has been filtered and cleaned of impurities.

Because of this typical installation, the known filters are usually identified as “under-boiler” filters; moreover, in the jargon of this technical sector, such filters are called “dirt separators”, because of their function of removing impurities.

Providing that the filter may be opened in order to carry out periodic maintenance operations, and in particular to remove the impurities collected by the filter or replace the filtering elements, is likewise known.

One known type of filter provides both for the use of mesh filtering elements, which retain impurities such as sand and dirt, and the use of filtering elements of a magnetic type, which enable the ferrous particles to be separated from the fluid in transit by attracting them and holding them in contact with the magnetic element.

An example of a mechanical magnetic filter is described in European patent application EP3159313A1. This solution envisages a filter body provided with three distinct inlet/outlet mouths, identical to one another, two of which lateral, in opposite positions of the body, and an upper one; essentially, the three mouths are arranged like a “T”. At the time of installation, it is possible to select which of the three mouths will be connected to the return line of the system and which must instead be connected to the line delivering to the boiler. This allows the filter to be installed vertically or horizontally, based on the space available beneath the boiler (which in some cases is very limited) and the position of the wall the boiler is fixed to, by appropriately connecting the mouths.

The Applicant has found that the prior art solutions described above are not without drawbacks and could be improved in several respects.

First of all, some known solutions featuring three mouths arranged like a “T” are capable of effectively filtering only when the central mouth, i.e. the one situated on top of the filter body, is used for the entry of fluid into the filter or for the exit of fluid from the filter. This is because such known solutions envisage a cylindrical mesh filter element (mechanical filtration) arranged longitudinally inside the filtration chamber, for the whole length of the chamber itself, and a magnetic filtering element arranged, in turn, inside the cylindrical mesh element. In this configuration, the central mouth (situated on top of the body of the cylinder) is inside the cylindrical mesh element, whereas the two lateral mouths (on opposite sides of the body of the cylinder) are instead outside the cylindrical mesh element.

This means, in particular in configurations in which the two lateral mouths are used for the entry of the fluid to be filtered and the exit of the filtered fluid (and the upper mouth is capped), that the flow can easily travel through the filtration chamber, passing around the cylindrical mesh element, without being obliged to pass through it, and as a result most of the fluid passes through the filter without being subjected to mechanical filtering (i.e. without passing through the mesh), with a consequent reduced filtering of impurities and dirt, and without transiting in proximity to the magnetic element, with a consequent reduced filtering of the ferrous particles.

In short, although some of the known solutions are proposed for a use according to various configurations, intended to meet different installation needs, they operate efficiently in one configuration only, whereas in other configurations there is no passage of the entire flow through the filtering elements, only a simple transit from the inlet mouth to the outlet mouth.

In addition, the known solutions pose a risk of clogging of the cylindrical mesh element that performs the mechanical filtering, because of the non-optimal management of the flows circulating inside the filtration chamber. Clogging introduces a decrease in the rate of flow through the filter, or even complete obstruction. Furthermore, the known filters are not able to provide effective solutions, in terms of assembly, access and maintenance, for all the different installation conditions and the different types of boilers, heat exchangers or heat pumps.

In this situation the object at the basis of the present invention, in the various aspects and/or embodiments thereof, is to provide a device and a method for filtering a fluid that may be capable of remedying one or more of the above-mentioned drawbacks.

A further object of the present invention is to provide a device and a method capable of achieving an effective filtration of a fluid circulating in a plumbing and heating system.

A further object of the present invention is to provide a device for filtering a fluid that is characterised by great versatility and is capable of being adapted to a high number and different types of boilers or other components of a heating system.

A further object of the present invention is to provide a device for filtering a fluid capable of operating with consistent high performances irrespective of the mode of installation inside a plumbing and heating system.

A further object of the present invention is to provide a device for filtering a fluid characterised by a high operating reliability and/or a lower predisposition to faults and malfunctions and/or which is capable of being maintained in a simple and rapid manner.

A further object of the present invention is to provide a device for filtering a fluid characterised by a simple and rational structure.

A further object of the present invention is to provide a device for filtering a fluid characterised by a low production cost in relation to the performances and quality offered.

A further object of the present invention is to create alternative solutions to the prior art in the construction of devices and methods for filtering a fluid circulating in a plumbing and heating system, and/or to open new fields of design.

These objects, and any others that will become more apparent in the course of the following description, are substantially achieved by a device for filtering a fluid and a method for filtering a fluid according to one or more of the appended claims, each of which taken on its own (without the related dependencies) or in any combination with the other claims, as well as according to the following aspects and/or embodiments, differently combined, also with the aforesaid claims.

In a first aspect thereof, the invention relates to a device for filtering a fluid, comprising a body of the device which defines therewithin a filtration chamber that is destined to have a fluid to be subjected to filtration pass through it, said body being provided with:
a first inlet/outlet opening, which sets said filtration chamber in communication with the outside of the device and is configured to be associated with a line so as to receive therefrom, or to send thereto, fluid entering, or exiting from, said body of the device;
a second inlet/outlet opening, which sets said filtration chamber in communication with the outside of the device and is configured to be associated with a respective line so as to receive therefrom, or to send thereto, fluid entering, or exiting from, said body of the device;
a third inlet/outlet opening, which sets said filtration chamber in communication with the outside of the device and is configured to be associated with a respective line so as to receive therefrom, or to send thereto, fluid entering, or exiting from, said body of the device.

In one aspect, the device is configured to bring about a passage of fluid through said filtration chamber, in a selective manner according to a plurality of operative configurations, from one opening among said first inlet/outlet opening, second inlet/outlet opening and third inlet/outlet opening to another opening among said first inlet/outlet opening, second inlet/outlet opening and third inlet/outlet opening.

In one aspect, the device comprises filtering members that are at least partially housed inside said filtration chamber, or associated with said body of the device, and operatively interposed between said first inlet/outlet opening, second inlet/outlet opening and third inlet/outlet opening to carry out filtering of the fluid passing through the filtration chamber.

In one aspect, the filtering members comprise at least one filtering septum configured to perform a mechanical separation of substances and solid particles present in the fluid to be treated from the fluid in which they are suspended, said filtering septum being arranged inside said filtration chamber so as to subdivide, preferably longitudinally, the filtration chamber into a first half-chamber and a second half-chamber.

In one aspect, the first half-chamber is in fluid communication (only) with the first inlet/outlet opening (and not with the second and/or the third opening), without passage through the filtering septum.

In one aspect, the second half-chamber is in fluid communication (only) with the second inlet/outlet opening and with the third inlet/outlet opening (and not with the first opening), without passage through the filtering septum.

In one aspect, the device is configured in such a manner that in each one of said plurality of operative configurations, in order to pass from said first half-chamber to said second half-chamber, or vice versa, the fluid transiting in the filtration chamber, (necessarily) passes through said filtering septum.

In one aspect, the device is configured to be associated with or installed along a delivery line, or in series with a delivery line, carrying a fluid to equipment of a plumbing and heating system, to perform a filtration of the fluid circulating in the system in a position upstream of such equipment.

In one aspect, the passage between the first half-chamber and the second half-chamber necessarily takes place through the filtering septum.

In one aspect, the first half-chamber and the second half-chamber communicate with each other only through the filtering septum.

In one aspect, the filtering septum has, at least partially, a structure provided with a plurality of passages having a given filtering section, so that the passage of the fluid from a first side of the filtering septum to a second side of the filtering septum determines retention, on the first side, of the substances and particles present in the fluid and having dimensions greater than said filtering section.

Conversely, if the passage of the fluid takes place from the second side of the filtering septum to the first side of the filtering septum, the retention of the substances and particles present in the fluid and having dimensions greater than said filtering section takes place on the second side.

In one aspect, the filtering septum has the form of a thin sheet or membrane that extends longitudinally on a plane of extension between an upper end and a lower end.

In one aspect, the filtering septum is positioned in the filtration chamber in such a manner that the first side thereof faces the first inlet/outlet opening and the second side thereof faces the third inlet/outlet opening and/or the second inlet/outlet opening.

In one aspect, said filtering septum is configured to operate in a single position for use which is maintained for each one of said plurality of operative configurations taken on by the device, in which:
it prevents the fluid from passing directly from the first opening to the second opening or from the first opening to the third opening, without passing through the filtering septum;
it prevents the fluid from passing directly from the second opening to the first opening or from the third opening to the first opening without passing through the filtering septum.

In one aspect, the filtering septum does not need to be moved when the operative configuration taken on by the device changes.

In one aspect, said filtering septum is configured to operate in a single position for use, which is maintained for each one of said plurality of operative configurations taken on by the device, in which:
passage of the fluid from the first opening to the second opening or from the first opening to the third opening takes place by passage through the filtering septum;
a passage of the fluid from the second opening to the first opening or from the third opening to the first opening takes place by passage through the filtering septum.

In one aspect, the aforesaid plurality of operative configurations comprises at least:
a first operative configuration, in which said first opening receives a flow of fluid entering the device, said second opening sends the flow of filtered fluid exiting from the device and said third opening is intercepted by a closure element;
a second operative configuration, in which said first opening receives a flow of fluid entering the device, said third opening sends the flow of filtered fluid exiting from the device and said second opening is intercepted by a closure element;
a third operative configuration, in which said third opening receives a flow of fluid entering the device, said first opening sends the flow of filtered fluid exiting from the device and said second opening is intercepted by a closure element;
a fourth operative configuration, in which said second opening receives a flow of fluid entering the device, said first opening sends the flow of filtered fluid exiting from the device and said third opening is intercepted by a closure element.

In one aspect, the device comprises said closure element, configured to selectively intercept one opening among said first inlet/outlet opening, second inlet/outlet opening and third inlet/outlet opening.

In one aspect, the aforesaid operative configurations provide for passage of the fluid through the filtering septum (from the first side to the second side) when the fluid enters the device from the first inlet/outlet opening and leaves the device from the second inlet/outlet opening or from the third inlet/outlet opening.

In one aspect, the aforesaid operative configurations provide for passage of the fluid through the filtering septum (from the second side to the first side) when the fluid enters the device from the second inlet/outlet opening or from the third inlet/outlet opening and leaves the device from the first inlet/outlet opening.

In one aspect, when the fluid enters the device from the second inlet/outlet opening and leaves from the third inlet/outlet opening, or vice versa, and the first inlet/outlet opening is intercepted by a closure element, there is not necessarily any passage of fluid through the filtering septum and the filtration, of a magnetic type, takes place by means of said at least one first magnetic filter.

In one aspect, the filtration chamber is delimited laterally by a lateral surface, above by a top surface and below by a bottom surface of the body of the device.

In one aspect, the filtering members comprise at least one magnetic filter associated with the body of the device and configured to collect and retain substances and ferrous particles (or particles having ferromagnetic properties) that are present in the fluid to be treated, in such a manner as to separate them from the fluid passing through the device.

In an independent aspect thereof, the present invention relates to a heating system comprising a device according to one or more of the above aspects.

In an independent aspect thereof, the present invention relates to a method for filtering a fluid circulating in a plumbing and heating system, comprising the steps of:
arranging at least one device for filtering a fluid;
identifying a line coming from a plumbing and heating system, particularly a heating water return line from a system of heating elements, carrying a flow of water to be subjected to filtration;
identifying a line directed to a boiler of the plumbing and heating system, this line carrying a flow of water that has undergone filtration to the boiler;
operating the device selectively in one of the following operative configurations:
   a first operative configuration, comprising the steps of:
      hydraulically connecting the first inlet/outlet opening with a line coming from a plumbing and heating system, particularly a heating water return line from a system of heating elements, so as to receive a flow of water to be subjected to filtration;
      hydraulically connecting the second inlet/outlet opening with a line directed to a boiler of the plumbing and heating system, so as to send thereto the flow of water following filtration;
      intercepting the third inlet/outlet opening by means of a closure element;
      introducing the flow of fluid entering the first opening into the first half-chamber, in such a manner that it is necessarily directed so as to pass through the filtering septum from the first side, undergoing mechanical filtration and leaving from the second side so as to flow into the second half-chamber;
      making the fluid travel through the second half-chamber, where it undergoes magnetic filtration by the magnetic filter, and making the fluid leave from the second inlet/outlet opening, the third inlet/outlet opening being intercepted;
   a second operative configuration, comprising the steps of:
      hydraulically connecting the first inlet/outlet opening with a line coming from a plumbing and heating system, particularly a heating water return line from a system of heating elements, so as to receive a flow of water to be subjected to filtration;
      intercepting the second inlet/outlet opening by means of a closure element;
      hydraulically connecting the third inlet/outlet opening with a line directed to a boiler of the plumbing and heating system, so as to send thereto the flow of water following filtration;
      introducing the flow of fluid entering the first opening into the first half-chamber, in such a manner that it is necessarily directed so as to pass through the filtering septum from the first side, undergoing mechanical filtration and leaving from the second side so as to flow into the second half-chamber;
      making the fluid travel through the second half-chamber, where it undergoes magnetic filtration by the magnetic filter, and making the fluid leave from the third inlet/outlet opening, the second inlet/outlet opening being intercepted;
   a third operative configuration, in which:
      the third inlet/outlet opening is hydraulically connected with a line coming from a plumbing and heating system, particularly a heating water return line from a system of heating elements, so as to receive a flow of water to be subjected to filtration;
      the second inlet/outlet opening is intercepted by a closure element;
      the first inlet/outlet opening is hydraulically connected with a line directed to a boiler of the plumbing and heating system, so as to send thereto the flow of water following filtration;
      the flow of fluid entering the third opening is introduced into the second half-chamber, where it undergoes magnetic filtration by the magnetic filter, and in such a manner that—the second inlet/outlet opening being intercepted—the fluid is necessarily directed so as to pass through the filtering septum from the second side, undergoing mechanical filtration and leaving from the first side so as to flow into the first half-chamber;
      the fluid is made to travel through the first half-chamber and the fluid is made to leave from the first inlet/outlet opening;
   a fourth operative configuration, comprising the steps of:
      hydraulically connecting the second inlet/outlet opening with a line coming from a plumbing and heating system, particularly a heating water return line from a system of heating elements, and receiving a flow of water to be subjected to filtration;
      intercepting the third inlet/outlet opening by means of a closure element;
      hydraulically connecting the first inlet/outlet opening with a line directed to a boiler of the plumbing and heating system, so as to send thereto the flow of water following filtration;
      introducing the flow of fluid entering the second opening into the second half-chamber, where it undergoes magnetic filtration by the magnetic filter, and in such a manner that—the third inlet/outlet opening being intercepted—the fluid is necessarily directed so as to pass through the filtering septum from the second side, undergoing mechanical filtration and leaving from the first side so as to flow into the first half-chamber;
      making the fluid travel through the first half-chamber and making the fluid leave from the first inlet/outlet opening.

Each of the aforesaid aspects of the invention can be taken on its own or in combination with any of the claims or the other aspects described.

Additional features and advantages will become more apparent from the detailed description of some example, but not exclusive, embodiments, including a preferred embodiment, of a device and a method for filtering a fluid circulating in a plumbing and heating system in accordance with the present invention. This description is provided herein below with reference to the attached drawings, which are provided solely for purpose of providing approximate and thus non-limiting examples, and of which:

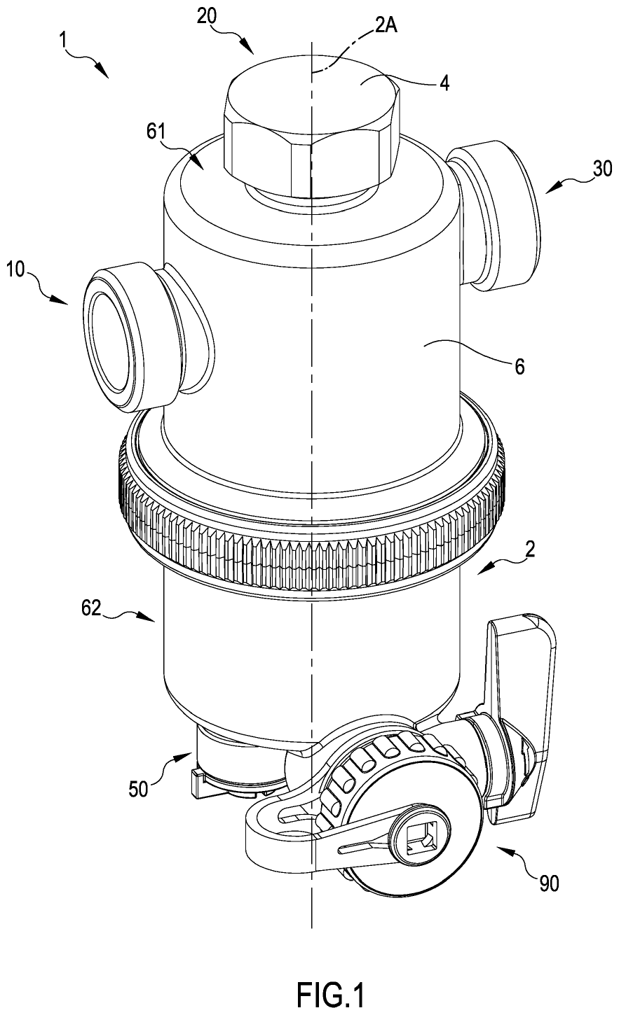

FIG. 1 illustrates a possible embodiment of a device for filtering a fluid according to the present invention;

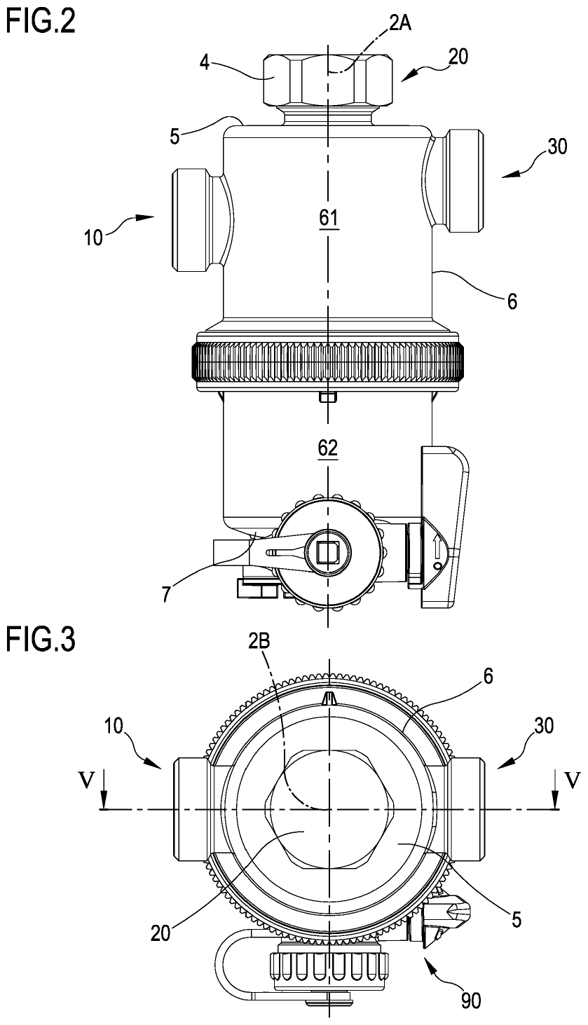

FIG. 2 shows a front view of the device of FIG. 1;

FIG. 3 shows a top view of the device of FIG. 1;

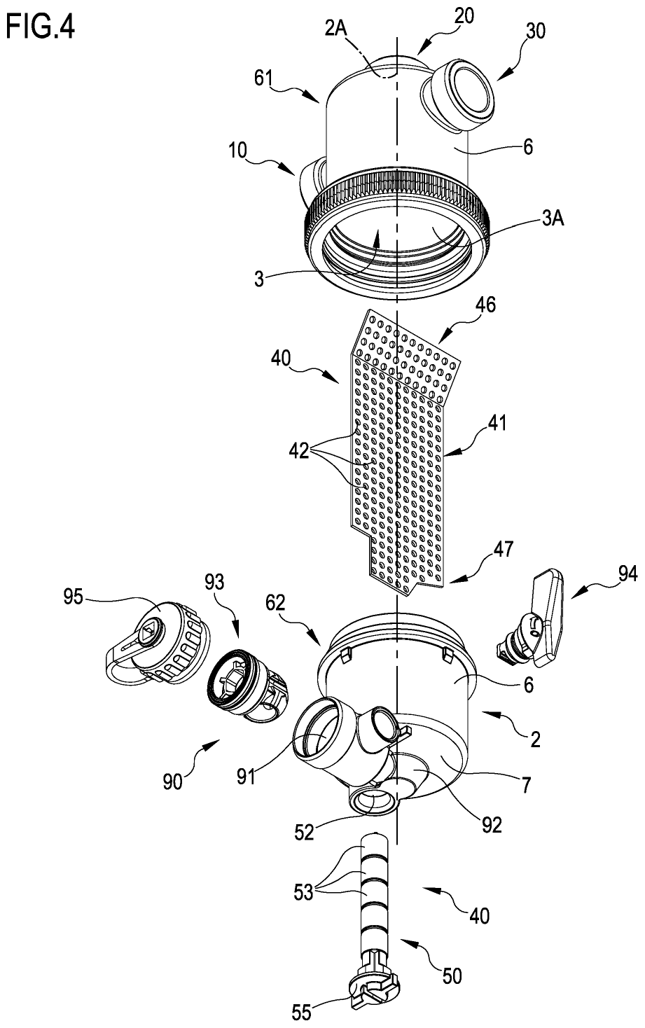

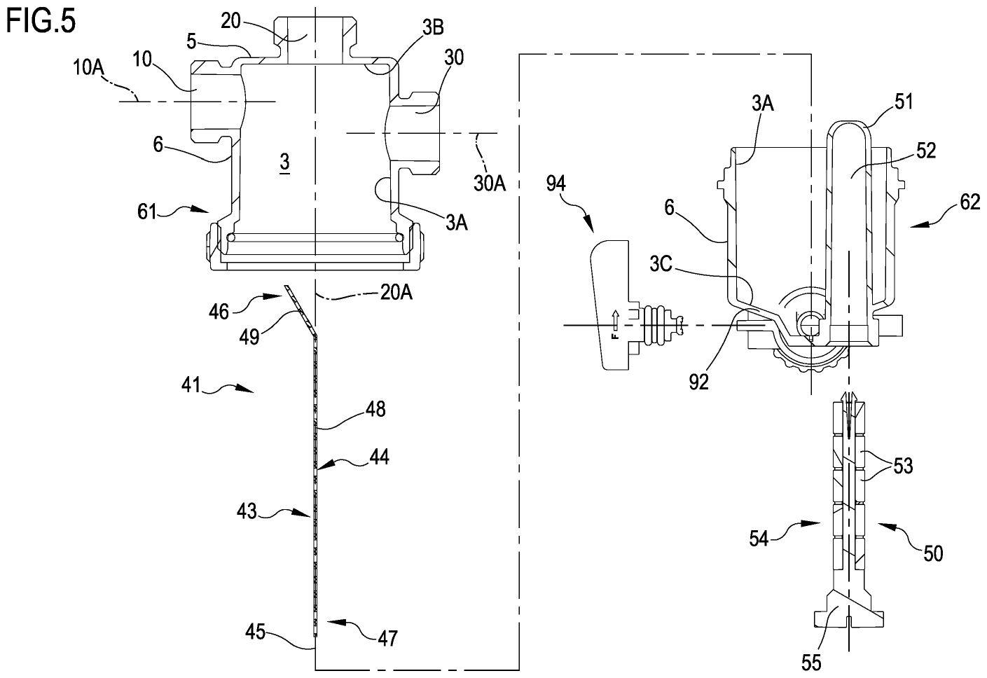

FIG. 4 shows an exploded perspective view of the device of FIG. 1;

FIG. 5 shows a sectional view, along the plane V-V, and exploded view of the device of FIG. 1, along a longitudinal direction, with some parts removed;

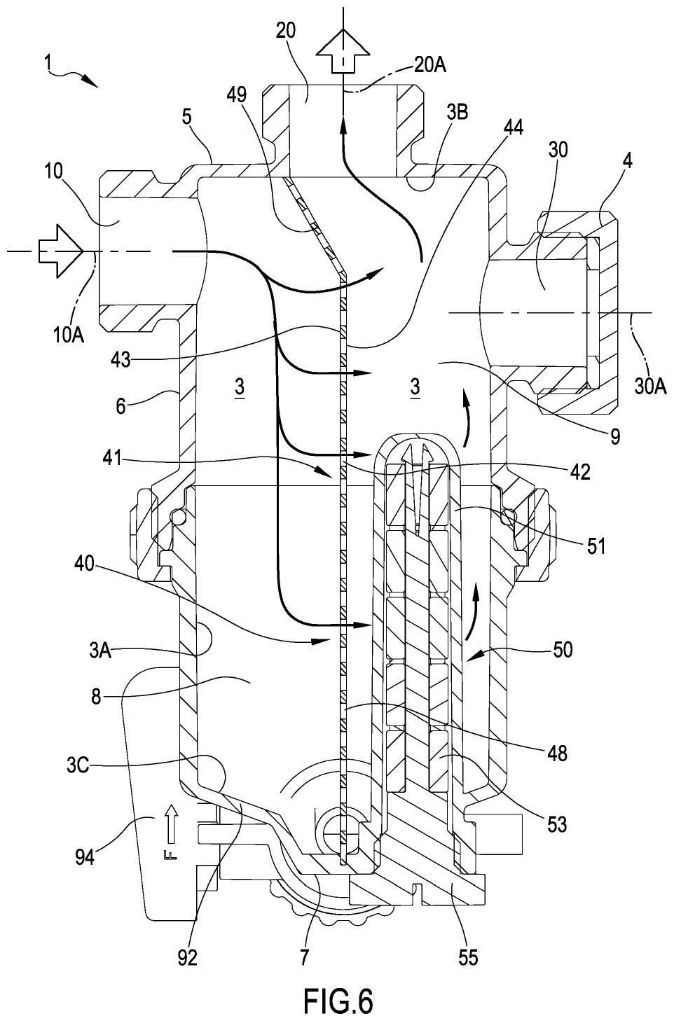

FIG. 6 shows the device of FIG. 1, sectioned along the plane V-V in a first operative configuration;

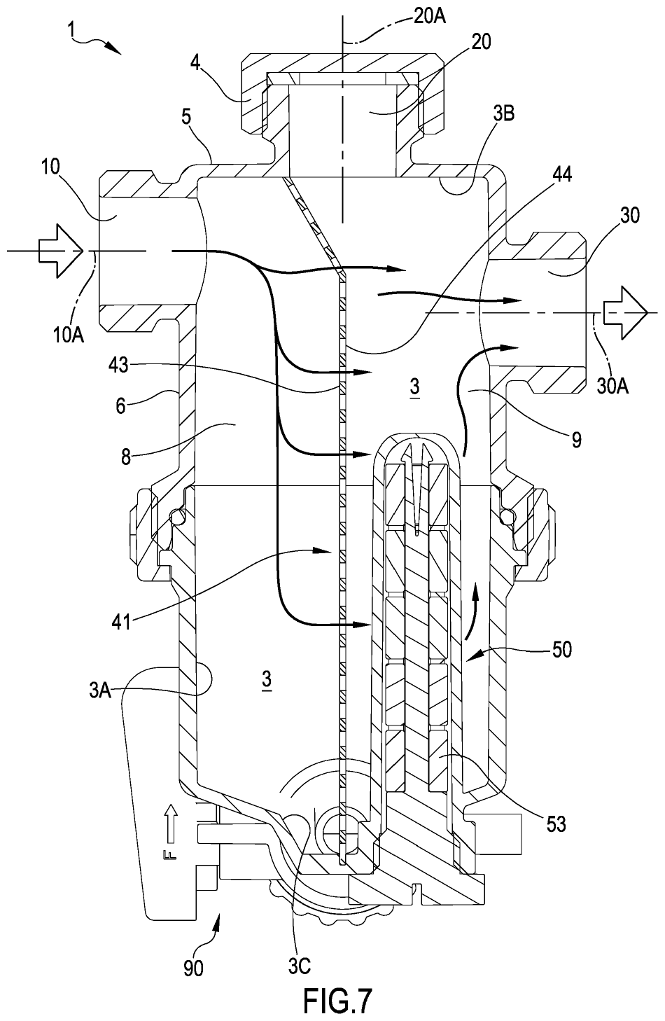

FIG. 7 shows the device of FIG. 1, sectioned along the plane V-V in a second operative configuration;

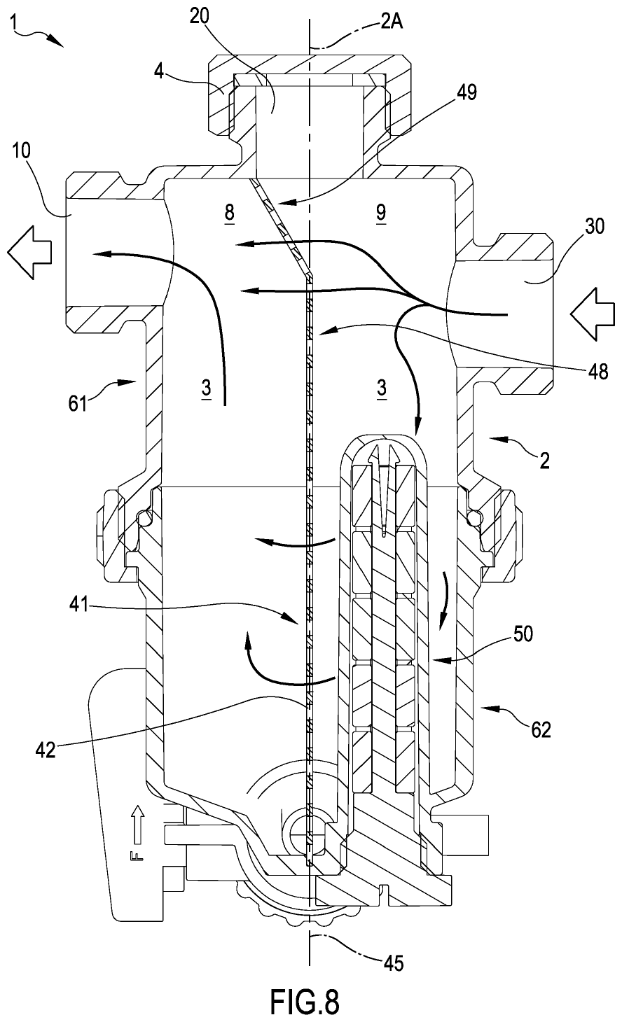

FIG. 8 shows the device of FIG. 1, sectioned along the plane V-V in a third operative configuration;

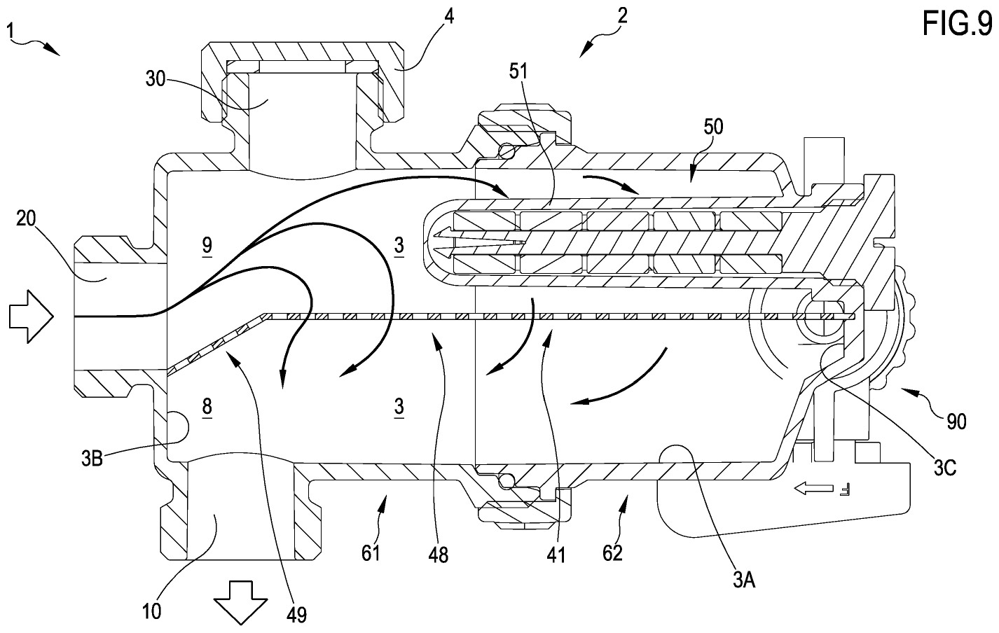

FIG. 9 shows the device of FIG. 1, sectioned along the plane V-V in a fourth operative configuration;

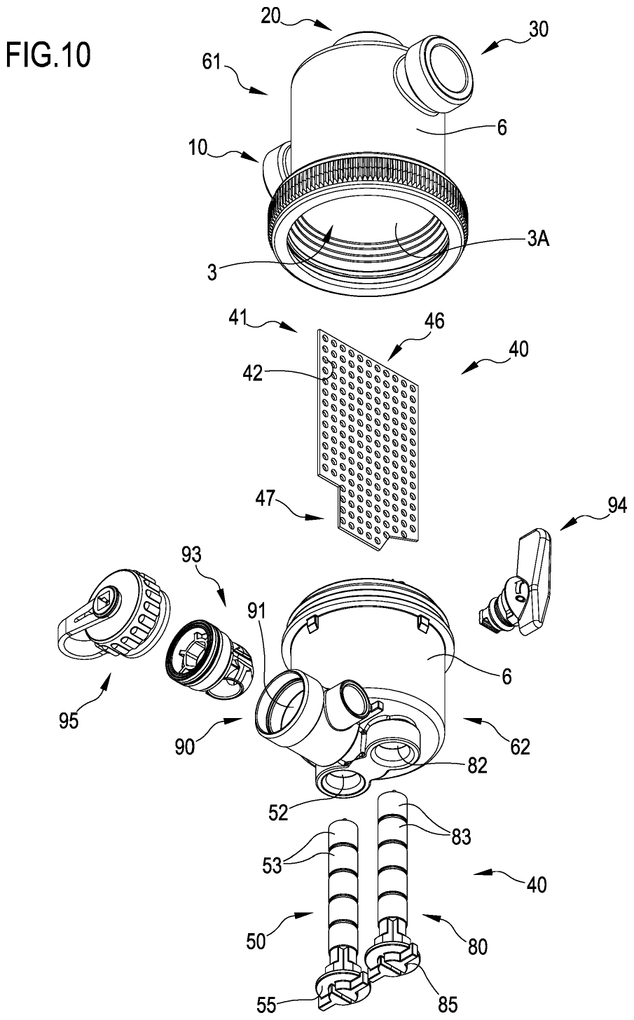

FIG. 10 shows an exploded perspective view of a further possible embodiment of a device per the filtration of a fluid according to the present invention;

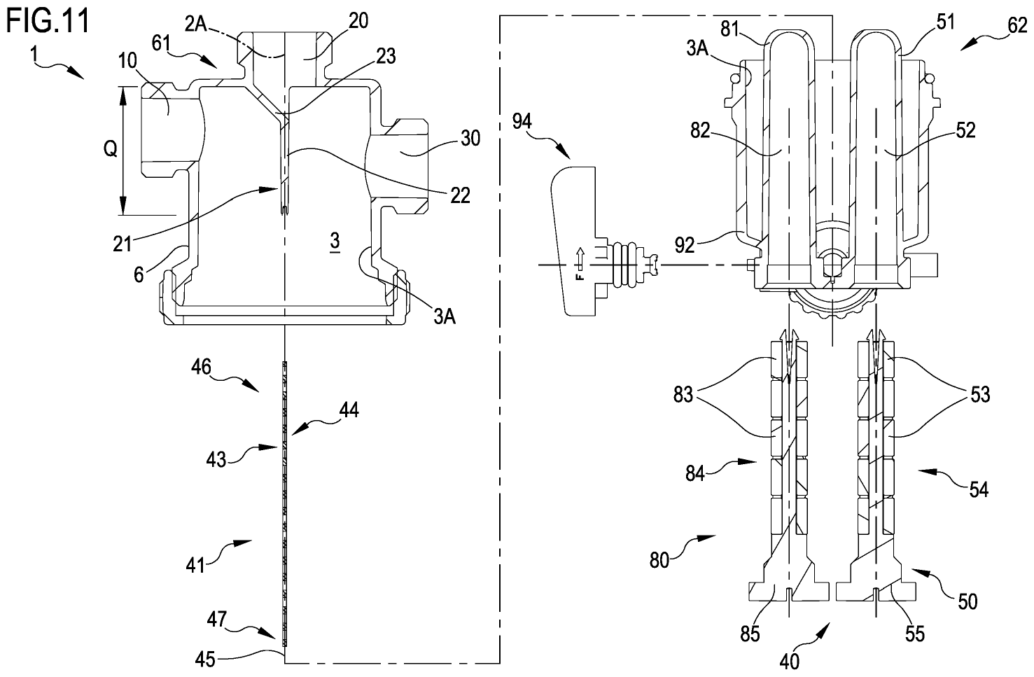

FIG. 11 shows a sectional view, along the longitudinal plane, and exploded view of the device of FIG. 10, along a longitudinal direction, with some parts removed;

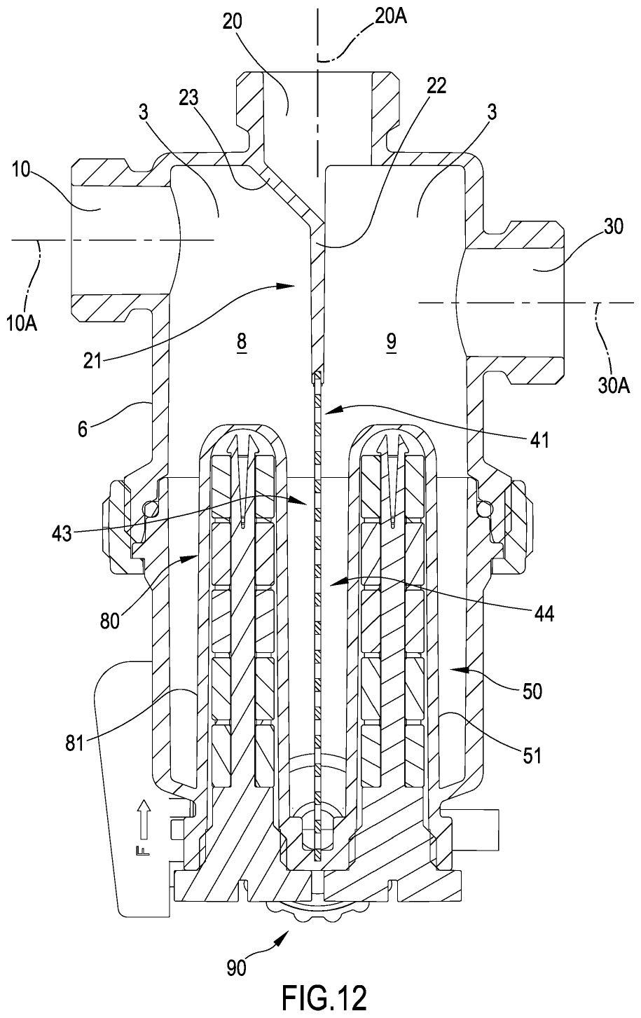

FIG. 12 shows the device of FIG. 10, sectioned along a central longitudinal plane;

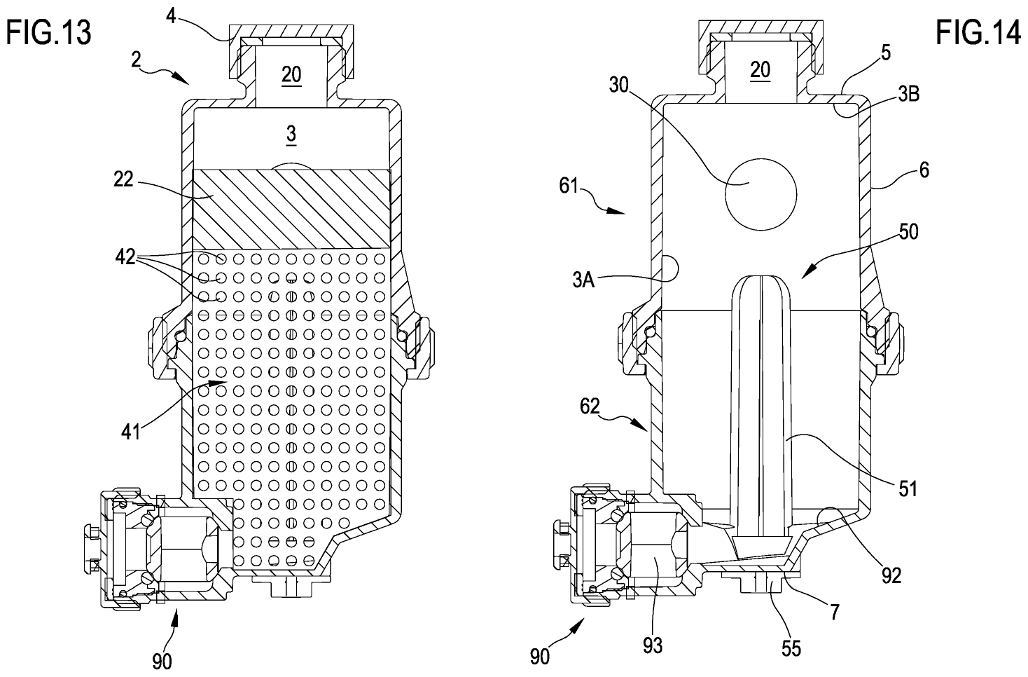

FIG. 13 shows the device of FIG. 10, sectioned along a central longitudinal plane, perpendicular to the section plane of FIG. 12;

FIG. 14 shows the device of FIG. 13 with the filtering septum removed.

With reference to the above-mentioned figures, the reference number 1 denotes in its entirety a device for filtering a fluid in accordance with the present invention. In general, the same reference number is used for identical or similar elements, possibly in the variant embodiments thereof.

The device 1 is destined to carry out the filtration of the fluid, typically water, circulating inside a plumbing and heating system, usually comprising pipes and conduits, valves, a boiler or a power generator, pumps, radiant elements (heaters, radiators, floor heating coils, etc.), utilities, etc.

In the figures the system for which the device is destined is not illustrated or described in a detailed manner, since it is in itself known in the technical field of the present invention.

The device 1 comprises first of all a body 2, which defines therewithin a filtration chamber 3 destined to have a fluid to be subjected to filtration pass through it. The body 2 is provided with a first inlet/outlet opening 10, a second inlet/outlet opening 20 and a third inlet/outlet opening 30: each one of them sets said filtration chamber 3 in communication with the outside of the device and is configured to be associated with a line of the system so as to receive therefrom, or to send thereto, fluid entering, or exiting from, said body of the device.

The device 1 is configured to bring about a passage of fluid through the filtration chamber 3, from one opening among said first inlet/outlet opening 10, second inlet/outlet opening 20 and third inlet/outlet opening 30 to another opening among said first inlet/outlet opening 10, second inlet/outlet opening 20 and third inlet/outlet opening 30. The two openings (among the aforesaid three openings 10, 20 and 30) between which the passage of fluid takes place can be selected as desired, according to a plurality of operative configurations, as will emerge more clearly below.

The device 1 comprises filtering members 40 that are at least partially housed inside the filtration chamber 3, or associated with the body 2 of the device, and operatively interposed between the three inlet/outlet openings 10, 20 and 30, to carry out filtering of the fluid passing through the filtration chamber 3.

The filtering members comprise at least one filtering septum 41 configured to perform a mechanical separation of substances and solid particles present in the fluid to be treated from the fluid in which they are suspended.

The filtering septum 41 is arranged inside the filtration chamber 3 so as to subdivide it, preferably longitudinally, into a first half-chamber 8 and a second half-chamber 9, wherein:
the first half-chamber 8 is in fluid communication only with the first inlet/outlet opening 10, and not with the second 20 and the third inlet/outlet opening 30, without passage through the filtering septum 41;
the second half-chamber 9 is in fluid communication only with the second inlet/outlet opening 20 and with the third inlet/outlet opening 20, and not with the first inlet/outlet opening 10, without passage through the filtering septum 41.

In this manner, the fluid transiting in the filtration chamber 3, in each one of said plurality of operative configurations, necessarily passes through the filtering septum 41 in order to pass from the first half-chamber 8 to the second half-chamber 9, or vice versa.

The device preferably comprises a closure element 4 configured to selectively intercept one opening among the aforesaid first inlet/outlet opening 10, second inlet/outlet opening 20 and third inlet/outlet opening 30.

According to a preferred embodiment, the plurality of operative configurations comprises:
a first operative configuration, in which the first opening 10 receives a flow of fluid entering the device, the second opening 20 sends the flow of filtered fluid exiting from the device and the third opening is intercepted by the closure element 4;
a second operative configuration, in which the first opening 10 receives a flow of fluid entering the device, the third opening 30 sends the flow of filtered fluid exiting from the device and the second opening 20 is intercepted by the closure element 4;
a third operative configuration, in which the third opening 30 receives a flow of fluid entering the device, the first opening 10 sends the flow of filtered fluid exiting from the device and the second opening 20 is intercepted by the closure element 4;
a fourth operative configuration, in which the second opening 20 receives a flow of fluid entering the device, the first opening 10 sends the flow of filtered fluid exiting from the device and the third opening 30 is intercepted by the closure element 4.

The closure element 4 is preferably a cap, removably associable with the openings.

It is evident that in each one of the operative configurations, one of the three openings acts as an inlet, another of the three openings acts as an outlet and the remaining opening is closed off and preferably not used.

The operative configurations are represented in FIGS. 6-9, and will be discussed in detail in the description below.

It should be considered that, in each of the four configurations identified above, irrespective of which opening receives the flow of fluid entering the device, which one sends the flow of filtered fluid exiting from the device, and which one is intercepted, the filtering septum 41 is always positioned in the same manner, and operates correctly without any need for the position or configuration thereof to be modified.

As shown by way of example in the embodiments illustrated in the figures, the passage between the first half-chamber 8 and the second half-chamber 9 preferably takes place necessarily through the filtering septum 41. In other words, the first half-chamber 8 and the second half-chamber 9 preferably communicate with each other only through the filtering septum 41.

The filtering septum 41 preferably has, at least in one portion thereof, a structure provided with a plurality of passages 42 that have a given filtering section, so that the passage of the fluid from a first side 43 of the filtering septum to a second side 44 of the filtering septum determines retention, on the first side 43, of the substances and particles present in the fluid and having dimensions greater than said filtering section.

Conversely, in a wholly analogous manner, if the passage of the fluid takes place from the second side 44 of the filtering septum 41 to the first side 43 of the filtering septum 41, the retention of the substances and particles present in the fluid and having dimensions greater than the filtering section takes place on the second side 44.

The passages 42 are preferably through holes or openings between the first side and the second side. The passages are preferably distributed evenly over the whole structure of the filtering septum.

The structure of the separating septum preferably has a meshwork (or a grid or a network or a fabric) or a plurality of micro holes.

It should be observed that the holes 42 indicated in the figures are only approximate; said holes can have different sizes and/or shapes, based on the different applications and the desired filtering section.

The filtering septum 41 preferably has the form of a thin sheet or a membrane that extends longitudinally on a plane of extension 45 between an upper end 46 and a lower end 47 (with reference to the orientation shown in the figures, and in particular in FIGS. 4 and 10).

The filtering septum 41 is preferably positioned in the filtration chamber 3 in such a manner that the first side 43 thereof faces the first inlet/outlet opening and the second side 44 thereof faces the third inlet/outlet opening 30 and the second inlet/outlet opening 20.

The filtering septum 41 is preferably configured to operate in a single position for use which is maintained for each one of said plurality of operative configurations taken on by the device, in which:
it prevents the fluid from passing directly from the first opening 10 to the second opening 20 or from the first opening 10 to the third opening 30 without passing through the filtering septum;
it prevents the fluid from passing directly from the second opening 20 to the first opening 10 or from the third opening 30 to the first opening 10 without passing through the filtering septum.

In short, the filtering septum 41 prevents the fluid from passing from the first half-chamber 8 to the second half-chamber 9, and from the second half-chamber 9 to the first half-chamber 8 without passing through the filtering septum. During use, the filtering septum 41 does not need to be moved when the operative configuration taken on by the device 1 changes.

In other words, the filtering septum 41 is configured to operate in a single position for use, which is maintained for each one of said plurality of operative configurations taken on by the device, in which:
passage of the fluid from the first opening 10 to the second opening 20 or from the first opening 10 to the third opening 30 takes place by passage through the filtering septum 41;
passage of the fluid from the second opening 20 to the first opening 10 or from the third opening 30 to the first opening 10 takes place by passage through the filtering septum 41.

In the figures showing the filtering septum 41, the upper end 46 of the filtering septum 41 along the plane of extension 45 faces upwards, whereas the lower end 47 faces downwards.

The filtering septum 41 is preferably made in one piece. The filtering septum 41 is preferably made of plastic or metallic material, for example stainless steel.

The aforesaid operative configurations preferably provide for passage of the fluid through the filtering septum 41 (from the first side 43 to the second side 44) when the fluid enters the device from the first inlet/outlet opening 10 and leaves the device from the second inlet/outlet opening 20 or from the third inlet/outlet opening 30 (FIGS. 6 and 7).

The aforesaid operative configurations preferably provide for passage of the fluid through the filtering septum 41 (from the second side 44 to the first side 43) when the fluid enters the device from the third inlet/outlet opening 30 or from the second inlet/outlet opening 20 and leaves the device from the first inlet/outlet opening 10 (FIGS. 8 and 9).

According to the embodiments shown by way of example in the figures, the body 2 of the device has a substantially cylindrical conformation and has an axis of longitudinal extension 2A, a top surface 5, an external lateral surface 6 and a lower surface 7.

The body preferably has the conformation of a solid rotating about the longitudinal axis 2A and has a radial symmetry thereabout.

The first inlet/outlet opening 10 and the third inlet/outlet opening 30 are preferably located on the external lateral surface 6 of the body 2 of the device and on opposite sides with respect to the filtration chamber 3.

The second inlet/outlet opening 20 is preferably located on the upper surface 5 of the body 2 of the device.

The first inlet/outlet opening 10, the second inlet/outlet opening 20 and the third inlet/outlet opening 30 preferably have a circular cross section and each one has a respective central axis (the central axes of the openings are indicated in the figures by 10A, 20A and 30A, respectively).

The central axis 20A of the second inlet/outlet opening 20 preferably coincides with the axis of longitudinal extension 2A of the body 2 of the device.

The axis of longitudinal extension 2A of the body 2 of the device preferably lies on the plane of extension 45 of the filtering septum.

The respective central axis of the second inlet/outlet opening 20 preferably lies on the plane of extension 45 of the filtering septum 41.

The filtering septum 41 preferably has the conformation of a wall or a dividing element (between the two half-chambers 8 and 9).

The respective central axes 10A and 30A of the first inlet/outlet opening 10 and of the third inlet/outlet opening 30 preferably intersect (preferably in a same point inside the filtration chamber 3) the axis of longitudinal extension 2A of the body 2 of the device.

The respective central axes 10A and 30A of the first inlet/outlet opening 10 and of the third inlet/outlet opening 30 are preferably perpendicular to the longitudinal axis 2A of the body 2 of the device.

The respective central axes 10A and 30A of the first inlet/outlet opening 10 and of the third inlet/outlet opening 30 preferably coincide with each other.

The body of the device preferably has a central plane of symmetry V-V on which the longitudinal axis 2A lies, said central plane of symmetry dividing the body 2 of the device into two substantially identical halves. The plane V-V is indicated in FIG. 3, and the sections in FIGS. 5-9 and 11-12 are drawn with respect thereto.

The body of the device is substantially symmetrical also with respect to a median plane 2B, on which the longitudinal axis 2A lies and which is perpendicular to the central plane of symmetry V-V.

All three of the respective central axes 10A, 20A and 30A of the first opening 10, the second opening 20 and the third opening 30 preferably lie on the plane of symmetry V-V of the body 2 of the device.

The filtering septum 41 is preferably symmetrically subdivided into two halves by a plane (it corresponds to the median plane 2B in FIG. 3) on which the axis of longitudinal extension 2A of the body 2 lies.

The filtration chamber 3 is preferably delimited laterally by a lateral surface 3A, above by a top surface 3B and below by a bottom surface 3C of the body 2 of the device.

The filtering septum 41 is preferably positioned longitudinally between the bottom surface 3C and the top surface 3B of the filtration chamber of the body 2 of the device.

The filtering septum 41 preferably has two prevalent dimensions on the plane of extension 45 and a third smaller dimension perpendicular to the plane of extension.

The aforesaid two prevalent dimensions are a height of the filtering septum 41, along a direction coinciding with the axis of longitudinal extension 2A of the body, and a width of the filtering septum, along a direction perpendicular to the axis of longitudinal extension of the body.

The aforesaid height of the filtering septum 41 preferably substantially corresponds to the distance between the top surface 3B and the bottom surface 3C of the filtration chamber 3, so that the filtering septum is in contact at the top and bottom (preferably sealingly) with said surfaces of the filtration chamber 3.

The aforesaid width of the filtering septum preferably corresponds to a radial dimension (preferably a diameter) of the filtration chamber 3, so as to be in contact (preferably sealingly) with the lateral surface 3A of the filtration chamber 3. The third dimension of the filtering septum 41 preferably corresponds to the thickness thereof.

The filtering septum preferably subdivides the filtration chamber 3 into the first 8 and the second 9 half-chamber and is in contact with and/or has a fluid-tight seal with the lateral surface 3A, the top surface 3B and/or the bottom surface 3C.

Preferably, the first half-chamber 8 is defined between the filtering septum 41 (in particular the first side 43 thereof) and the first inlet/outlet opening 10, whilst the second half-chamber 9 is defined between the filtering septum 41 (in particular the second side 44 thereof) and the second 20 and third 30 inlet/outlet openings.

The first half-chamber 8 and the second half-chamber 9 preferably each have a prevalently semi-cylindrical conformation, and form overall—together with the filtering septum 41 placed between them—the single filtration chamber inside the body 2 of the device with a substantially or prevalently cylindrical conformation.

The filtering septum 41 is preferably arranged inside the filtration chamber 3 so that the subdivision of the filtration chamber into the first half-chamber 8 and second half-chamber 9 is of an axial type, i.e. substantially prevalently along the axis 2A of the body of the device.

As shown by way of example in the embodiment of FIGS. 4-9, the filtering septum 41 may comprise a first portion 48, comprising the lower end 47 at the bottom thereof and aligned with the axis of longitudinal extension 2A of the body 2, and a second portion 49, extending continuously above the first portion and terminating with the upper end 46, said second portion being inclined laterally with respect to the first portion.

The second portion 49 extends inside the filtration chamber 3 between the upper end of the first portion 48 of the filtering septum and a point of the top surface 3B interposed between the first inlet/outlet opening 10 and the second inlet/outlet opening 20.

Preferably, the second portion 49 extends continuously above the first portion 48, and the two portions together define a filtering septum 41 in a single body, i.e. a monobloc.

The second portion 49 is preferably positioned inside the filtration chamber 3 between the axis of longitudinal extension 2A of the body 2 and the first inlet/outlet opening 10.

In other words, the second portion 49 extends inside the filtration chamber 3 entirely in one half of the filtration chamber comprised between the median plane 2B, perpendicular to the central plane of symmetry V-V of the body 2 on which the axis of longitudinal extension 2A extends, and the first inlet/outlet opening 10.

By way of example, the second portion forms a constant angle with respect to the first portion.

According to a further possible embodiment, shown by way of example in FIGS. 10-14, the body of the device can be provided with a dividing wall 21 extending inside the filtration chamber 3 between the upper end of the filtering septum 41 and a point of the top surface interposed between the first inlet/outlet opening 10 and the second inlet/outlet opening 20.

The dividing wall preferably extends continuously with respect to the filtering septum 41, and together with the latter it contributes to subdividing the filtration chamber 3 longitudinally into the first half-chamber 8 and the second half-chamber 9.

The dividing wall 21 can preferably lie at least partially on the plane of extension 45 of the filtering septum and/or on the axis of longitudinal extension 2A of the body of the device.

Starting from one side of the second inlet/outlet opening 20, said side facing the first inlet/outlet opening 10, the dividing wall 21 preferably extends inside the filtration chamber 3 according to a direction substantially consistent with the axis of longitudinal extension 2A of the body of the device and substantially to a height Q coinciding with the dimensions of the first inlet/outlet opening 10 on the external lateral surface 6 of the body 2 of the device and/or with the dimensions of the third inlet/outlet opening 30 on the external lateral surface 6 of the body 2 of the device (see for example FIG. 12). According to said embodiment, the filtering septum 41 is positioned longitudinally between the bottom surface 3C of the body 2 of the device and the dividing wall 21. The filtering septum 41 is preferably positioned in the filtration chamber 3 below the dividing wall so as to be below the three inlet/outlet openings 10, 20 and 30 along the axis of longitudinal extension 2A of the body 2 of the device, in a direction away from the second inlet/outlet opening 20.

According to the embodiment shown by way of example in FIGS. 10-14, the dividing wall 21 can comprise a first portion 22 aligned with the filtering septum 41, and extending continuously from the upper end 46 thereof, and a second portion 23, extending continuously above the first portion 22 and inclined laterally with respect to the first portion 22. The second portion 23 extends inside the filtration chamber 3 between an upper end of the first portion 22 of the dividing wall 21 and a point of the top surface 3B interposed between the first inlet/outlet opening 10 and the second inlet/outlet opening 20. The second portion 23 preferably extends continuously above the first portion 22, and the two portions together contribute to defining a dividing wall 21 in a single body, i.e. a monobloc.

The dividing wall 21 preferably extends, starting from the second inlet/outlet opening 20, inside the filtration chamber 3 along a direction parallel to the axis of longitudinal extension 2A of the body 2 of the device and substantially to a height coinciding with the dimensions of the first inlet/outlet opening 10 on the external lateral surface 6 of the body 2.

The dividing wall 21 preferably extends, inside the filtration chamber 3, starting from the top surface 3B delimiting the filtration chamber 3 from above.

The dividing wall 21 is preferably fixed with respect to the body 2 of the device.

It should be observed that, both in the embodiment of FIGS. 4-9 and in the embodiment of FIGS. 10-14, the filtering septum 41—or respectively the dividing wall 21—ends at the top with a second portion (49 or, respectively, 23) that is inclined with respect to the first one (48 or, respectively, 22). That is because the filtering septum 41, or the dividing wall 21, must end at the top in a point interposed between the second opening 20 and the first opening 10: in fact, this enables the filtration chamber 3 to be subdivided into the first half-chamber 8 and second half-chamber 9. Given that in the embodiments the second inlet/outlet opening 20 has its axis coinciding with the axis of longitudinal extension 2A of the body 2, it is necessary for the filtering septum 41 or the dividing wall 21 to deviate (by inclining) from the axis 2A in order to correctly reach the point of the top surface 3B situated at the side of the second opening 20 and interposed between the latter and the first opening 10.

If the second inlet/outlet opening 20 were translated sideways with respect to the axis 2A, nearer to the third opening 30, the filtering septum 41 or—if present—the dividing wall 21 could have an entirely rectilinear, or planar conformation, and lie entirely on the axis of longitudinal extension 2A. The first inlet/outlet opening 10, the second inlet/outlet opening 20 and the third inlet/outlet opening 30 preferably have the same shape and size; more preferably, they are identical to one another.

The closure element 4 can preferably be selectively applied on any of the three inlet/outlet openings 10, 20 and 30, so as to determine the closure thereof. The first inlet/outlet opening 10, the second inlet/outlet opening 20 and the third inlet/outlet opening 30 preferably have respective interconnection means configured to fluidly connect the opening with external pipes, fittings or water valves. The interconnection means are preferably configured also to receive the closure element 4. The interconnection means preferably comprise threads or pressure connections or like mechanisms. The interconnection means of the first inlet/outlet opening 10, the second inlet/outlet opening 20 and the third inlet/outlet opening 30 are preferably structurally identical to one another. By way of example, the three inlet/outlet openings 10, 20 and 30 have standard sizes for the plumbing sector, for example a ¼ inch, ½ inch, ¾ inch or 1 inch diameter.

Reference will now be made in particular to FIGS. 4-9.

The filtering members 40 preferably comprise at least one first magnetic filter 50 associated with the body 2 of the device and configured to collect and retain substances and ferrous particles (or in general particles having ferromagnetic properties) present in the fluid to be treated, in such a manner as to separate them from the fluid passing through the device.

The body 2 of the device preferably comprises at least a first hollow protuberance 51 that emerges axially from the bottom surface 3C towards the top surface 3B, said first hollow protuberance 51 defining, outside the body of the device, a first housing 52 that is elongated in shape, corresponding (negatively) to the first hollow protuberance 51 and accessible from the lower surface 7; the first housing 52 accommodates within it the first magnetic filter 50.

The first hollow protuberance 51 preferably emerges axially inside the second half-chamber 9 (as shown by way of example in FIGS. 5-9). Alternatively, the first hollow protuberance can emerge axially inside said first half-chamber.

The magnetic filter 50 preferably comprises at least a first magnetic element 53, configured to generate a permanent magnetic field and inserted in the first housing 52 of the body 2 in such a manner as to act upon the fluid passing through the filtration chamber 3 and retain the substances and ferrous particles present in the fluid on the surface of the first hollow protuberance 51 inside the body 2 (in particular inside the chamber 3). In short, the first magnetic filter 50 is positioned “inside” the filtration chamber 3, even if it is physically in the first housing 52, which can be accessed from outside the body 2 without accessing the filtration chamber. The first hollow protuberance 51, emerging from the bottom surface 3C, is preferably laterally distanced from the filtering septum 41, and is entirely contained within the second half-chamber 9 (or alternatively the first half-chamber).

In this configuration, although the first magnetic filter 50 is not in direct contact with the flow, i.e. it is not directly touched by the fluid circulating in the filtration chamber, thanks to its position and its magnetic effect, it allows the ferrous particles to be blocked on the first hollow protuberance inside the body.

In an alternative embodiment, not shown, the magnetic filter can be housed directly inside the filtration chamber.

The magnetic filter 50 preferably comprises a plurality of first magnetic elements 53 associated with one another so as to form a first rod-shaped magnetic cartridge 54 inserted axially in the first housing 52 of the body of the device.

The first magnetic cartridge 54 preferably comprises a first cap 55 suitable for being removably associated with the access opening of the first housing 52, on the lower surface 7, so as to close off said first magnetic cartridge 54 inside the first housing 52 and enable the extraction thereof as needed.

The body 2 preferably comprises a first half-body 61 and a second half-body 62, removably associated with each other, wherein:
the assembly of the first half-body 61 with the second half-body 62 defines the filtration chamber 3, inside the body of the device, which is fluid tight towards the outside, with the exception of said first inlet/outlet opening 10, second inlet/outlet opening 20 and third inlet/outlet opening 30;
the disassembly of the first half-body 61 from the second half-body 62 enables access to the filtration chamber 3 and the positioning of the filtering septum 41, as well as cleaning or maintenance operations.

Preferably:
the first half-body 61 comprises the first inlet/outlet opening 10, the second inlet/outlet opening 20, the third inlet/outlet opening 30, the top surface 3B and the dividing wall 21 (if present);
the second half-body 62 comprises the bottom surface 3C and the first hollow protuberance 51.

The lateral surface 3A of the filtration chamber 3 is preferably defined in part by the first half-body 61 and in part by the second half-body 62.

The first half-body and the second half-body are preferably interconnected by means of a threaded coupling (not shown, of a known type).

The body 2 of the device preferably comprises a gasket interposed between the first half-body 61 and the second half-body 62 to ensure the tightness of the filtration chamber 3 in the assembled condition.

The four operative configurations introduced above are described below with reference to the specific FIGS. 6, 7, 8 and 9. These configurations correspond to the different possible operating modes of the device of the present invention. As illustrated, the device 1 is configured to operate selectively in one of the operative configurations, according to installation requirements.

The first operative configuration is shown in FIG. 6; in this configuration:
the first inlet/outlet opening 10 is destined to be set into communication with a line coming from a plumbing and heating system, particularly a heating water return line from a system of heating elements (for example heaters or radiators), so as to receive a flow of water to be subjected to filtration;
the second inlet/outlet opening 20 is destined to be set into communication with a line directed to a boiler of the plumbing and heating system, so as to send thereto the flow of water following filtration;
the third inlet/outlet opening 30 is intercepted by the closure element 4;
the flow of fluid entering the first opening 10 flows into the first half-chamber 8 and is necessarily directed so as to pass through the filtering septum 41 from the first side 43, undergoing mechanical filtration and leaving from the second side 44 so as to flow into the second half-chamber 9;
the fluid travels through the second half-chamber 9 where it undergoes magnetic filtration by the magnetic filter 50;
the fluid is conveyed towards the second inlet/outlet opening 20, the third inlet/outlet opening 30 being intercepted.

The second operative configuration is shown in FIG. 7; in this configuration:
the first inlet/outlet opening 10 is destined to be set into communication with a line coming from a plumbing and heating system, particularly a heating water return line from a system of heating elements (for example heaters or radiators), so as to receive a flow of water to be subjected to filtration;
the second inlet/outlet opening 20 is intercepted by the closure element 4;
the third inlet/outlet opening 30 is destined to be set into communication with a line directed to a boiler of the plumbing and heating system, so as to send thereto the flow of water following filtration;
the flow of fluid entering the first opening 10 flows into the first half-chamber 8 and is necessarily directed so as to pass through the filtering septum 41 from the first side 43, undergoing mechanical filtration and leaving from the second side 44 so as to flow into the second half-chamber 9;
the fluid travels through the second half-chamber 9 where it undergoes magnetic filtration by the magnetic filter 50;
the fluid is conveyed towards the third inlet/outlet opening 30, the second inlet/outlet opening 20 being intercepted.

The third operative configuration is shown in FIG. 8; in this configuration:
the third inlet/outlet opening 30 is destined to be set into communication with a line coming from a plumbing and heating system, particularly a heating water return line from a system of heating elements (for example heaters or radiators), so as to receive a flow of water to be subjected to filtration;
the second inlet/outlet opening 20 is intercepted by the closure element 4;
the first inlet/outlet opening 10 is destined to be set into communication with a line directed to a boiler of the plumbing and heating system, so as to send thereto the flow of water following filtration;
the flow of fluid entering the third opening 30 flows into the second half-chamber 9 where it undergoes magnetic filtration by the magnetic filter 50, and—the second inlet/outlet opening 20 being intercepted—it is thus necessarily directed so as to pass through the filtering septum 41 from the second side 44, undergoing mechanical filtration and leaving from the first side 43 so as to flow into the first half-chamber 8;
the fluid travels through the first half-chamber 8 and is conveyed towards the first inlet/outlet opening 10.

The fourth operative configuration is shown in FIG. 9; in this configuration:
the second inlet/outlet opening 20 is destined to be set into communication with a line coming from a plumbing and heating system, particularly a heating water return line from a system of heating elements (for example heaters or radiators), so as to receive a flow of water to be subjected to filtration;
the third inlet/outlet opening 30 is intercepted by the closure element 4;
the first inlet/outlet opening 10 is destined to be set into communication with a line directed to a boiler of the plumbing and heating system, so as to send thereto the flow of water following filtration;
the flow of fluid entering the second inlet/outlet opening 20 flows into the second half-chamber 9 where it undergoes magnetic filtration by the first magnetic filter 50, and—the third inlet/outlet opening 30 being intercepted—it is thus necessarily directed so as to pass through from the second side 44 the filtering septum 41, undergoing mechanical filtration and leaving from the first side 43 so as to flow into the first half-chamber 8;
the fluid travels through the first half-chamber 8 and is conveyed towards the first inlet/outlet opening 10.

Preferably:
in the first operative configuration, in the second operative configuration and in the third operative configuration the device is positioned vertically, i.e. with the axis of longitudinal extension 2A of the body 2 of the device vertically oriented;
in the fourth operative configuration the device is positioned horizontally, i.e. with the axis of longitudinal extension 2A of the body 2 of the device horizontally oriented.

Observe, in FIGS. 6-9, the arrows indicating the path of the fluid inside the device. In particular:
in the first configuration (FIG. 6) the fluid enters from the first opening 10, descends into the first half-chamber 8, passes through the filtering septum 41 (being mechanically filtered) and rises into the second half-chamber 9 (where it is mechanically filtered) until exiting from the second opening 20 (the third one is closed); the impurities and the residue of the mechanical filtration remain in the first half-chamber 8, whereas the impurities and the residue of the magnetic filtration remain in the second half-chamber 9;
in the second configuration (FIG. 7) the fluid enters from the first opening 10, descends into the first half-chamber 8, passes through the filtering septum 41 (being mechanically filtered) and rises into the second half-chamber 9 (where it is mechanically filtered) until exiting from the third opening 30 (the second one is closed); the impurities and the residue of the mechanical filtration remain in the first half-chamber 8, whilst the impurities and the residue of the magnetic filtration remain in the second half-chamber 9. If the boiler is positioned above the device, it is possible to connect an elbow fitting)(90° outside the third opening to rise towards the boiler.
in the third configuration (FIG. 8) the fluid enters from the third opening 30, descends into the second half-chamber 9, where it is mechanically filtered, passes through the filtering septum 41 (being mechanically filtered) and rises into the first half-chamber 8 until exiting from the first opening 10 (the only one communicating with the first half-chamber); the impurities and the residue of both the magnetic filtration and the mechanical filtration remain in the second half-chamber 9. If the boiler is positioned above the device, it is possible to connect an elbow fitting (90°) outside the first opening to rise towards the boiler.
in the fourth configuration (FIG. 9) the fluid enters from the second opening 20, passes horizontally into the second half-chamber 9, where it is mechanically filtered, passes through the filtering septum 41 (being mechanically filtered) and travels through the first half-chamber 8 until exiting from the first opening 10 (the only one communicating with the first half-chamber); the impurities and the residue of both the magnetic filtration and the mechanical filtration remain in the second half-chamber 9.

In short, in the third configuration the path of the fluid is opposite that of the second configuration, whereas in the fourth configuration the path of the fluid is opposite that of the first configuration.

It should be noted that in all four operative configurations, as represented, the opening that acts as an inlet for the fluid is horizontal, since it is destined to be connected to the return line from the system, which usually comes out of a wall under the boiler. In any case, the first, second and third configurations can also operate horizontally, and the fourth can also operate vertically. In this case it is possible to use suitable couplings, of a known type, to make the water connections between the openings acting as an inlet and outlet of the device and the pipes of the system to which they are to be connected.

It should be observed, moreover, that the paths of the fluid inside the device, in the four configurations, are obligatory thanks to the filtering septum and thanks to the structure and positioning of the elements of the body of the device.

Reference will now be made in particular to FIGS. 10-14. According to the example embodiment shown in said figures, the body 2 of the device can comprise a second hollow protuberance 81 that emerges axially, in the filtration chamber 3, from the bottom surface 3C towards the top surface 3B, said second hollow protuberance 81 defining, outside the body 2 of the device, a second housing 82 that is elongated in shape, corresponding to the second hollow protuberance and accessible from the lower surface 7.

The second hollow protuberance 81 preferably emerges axially inside the half-chamber not occupied by the first hollow protuberance 51.

Preferably, the second hollow protuberance 81 emerges axially inside the first half-chamber 8, whereas the first hollow protuberance 51 emerges axially inside the second half-chamber 9.

The second hollow protuberance 81, emerging from the bottom surface, is preferably laterally distanced from the filtering septum 41, and is entirely contained within the first half-chamber (or alternatively the second half-chamber if the first half-chamber contains the first hollow protuberance).

The first magnetic filter 50 can preferably be associated selectively with the first hollow protuberance 51 or the second hollow protuberance 81 of the body 2 of the device, depending on the selected operative configuration.

This can be done by removing the first cap 55 of the first magnetic filter and moving it into the desired housing 52 or 82.

When the first magnetic filter 50 is associated with the first hollow protuberance 51, it preferably carries out a magnetic filtration of the fluid in transit in the second half-chamber 9, whereas when the first magnetic filter 50 is associated with the second hollow protuberance 81 it carries out a magnetic filtration of the fluid in transit in the first half-chamber 8. In short, the device can comprise two hollow protuberances and a single magnetic filter 50, to be inserted selectively into the first housing 52 or the second housing 82. In both cases, since the operative configurations always provide for a passage of the fluid between the two half-chambers (and always a passage through the filtering septum 41), magnetic filtering by at least the magnetic filter 50 is ensured, irrespective of the housing in which it is inserted.

In a possible embodiment the filtering members 40 can further comprise a second magnetic filter 80 associated with the body 2 of the device and configured to collect and retain substances and particles having ferromagnetic properties present in the fluid to be treated, in such a manner as to separate them from the fluid passing through the device. The second magnetic filter 80 is preferably structurally identical to the first magnetic filter 50.

The second magnetic filter 80 preferably comprises at least one second magnetic element 83, configured to generate a permanent magnetic field, inserted in the second housing of the body 2 in such a manner as to act upon the fluid passing through the filtration chamber 3 and retain the ferromagnetic substances and particles present in the fluid on the surface of the second hollow protuberance 81 inside the body of the device.

The second magnetic element 83 is preferably structurally identical to the first magnetic element 53.

The second magnetic filter 80 preferably comprises a plurality of second magnetic elements 83 associated with one another so as to form a second rod-shaped magnetic cartridge 54 inserted axially in the second housing 82 of the body of the device.

The second magnetic cartridge 84 preferably comprises a second cap 85 suitable for being removably associated with the access opening of the second housing 82, on the lower surface 7, so as to close off said second magnetic cartridge 84 inside the second housing 82 and enable the extraction thereof as needed.

Preferably, the second magnetic filter 80 is destined to be housed in the second housing 82, whereas the first magnetic filter 50 is destined to be housed in the first housing 52.

It should be observed that the embodiment of FIGS. 10-14 operates in the same operative configurations as described with reference to FIGS. 6-9.

As shown both in FIGS. 6-9 and FIGS. 10-12, and further illustrated in FIGS. 13-14, the device can preferably comprise a drain cock 90 configured to enable the filtration chamber 3 to be emptied without disassembling the device from the system in which it is installed, without disconnecting the first, second, and third inlet/outlet openings from the respective lines, and without disassembling the body of the device (in particular the first half-body 61 and the second half-body 62).

The drain cock 90 is preferably positioned at a drain opening 91 located on the bottom surface 3C of the body 2 of the device and selectively enables the contents of the filtration chamber 3 to be emptied in order to carry out cleaning or maintenance of the device.

The drain opening 91 is preferably located on the bottom surface, straddling the lower end 47 of the filtering septum 41 in such a manner as to be laterally in communication with both the first half-chamber 8 and the second half-chamber 9, but without setting the first and the second half-chamber in communication with each other.

The drain opening 91 is preferably located at the lower end of an inclined portion 92 of the bottom surface 3C, extending downwards, that is, away from the top surface, with respect to the rest of the bottom surface, said inclined portion 92 enabling the material filtered inside the filtration chamber, particularly by the filtering septum 41, to be conveyed towards the drain opening, by gravity or settling.

The drain cock 90 can preferably be operated selectively in a closed state, in which the drain opening 91 is intercepted and does not allow the fluid to leave the filtration chamber 3, or an open state, in which the drain opening 91 is set in communication with the outside of the device 1.

The drain cock 90 preferably comprises an obturator 93 active on the drain opening 91 in such a manner as to intercept the drain opening, in said closed state, or leave the passage through the drain opening free, in said open state. The drain cock 90 preferably comprising a knob 94, or a similar manual or automatic means for selecting the position of the obturator 93.

The drain cock preferably comprises a removable safety cap 95 set downstream of the obturator 93 and configured, when it is located in position, to close the drain opening even if the knob takes the obturator into the open state.

It should be observed that, advantageously, the drain cock is configured, thanks to the positioning of the drain opening, to draw from both the half-chambers 8 and 9, so as to enable an effective discharge of the filtered material and cleaning of both half-chambers. This is particularly relevant since, as illustrated above, according to the operative configuration and the type of connection made for the first, the second and the third inlet opening, the material can be filtered on the first side 43 or second side 44 of the filtering septum 41, and thus accumulate in the first half-chamber 8 or in the second half-chamber 9. In either case the drain cock 90 enables easy cleaning of both half-chambers.

In a possible alternative embodiment, shown by way of example in the figures, the first inlet/outlet opening 10 and the third inlet/outlet opening 30 are not aligned with each other, i.e. the respective central axes 10A and 30A of the first inlet/outlet opening 10 and the third inlet/outlet opening 30 do not coincide with each other, but are rather offset. This means that the first inlet/outlet opening 10 and the third inlet/outlet opening 30 are positioned, on the external lateral surface 6 of the body 2, at different heights with respect to the second opening 20 along the axis of longitudinal extension. This makes it possible to have two different longitudinal distances, or distances between centres, between the first opening 10 and the second opening 20 and between the third opening 30 and the second opening 20. In this manner it is possible, advantageously, to select which opening to use as an inlet or as an outlet, either the first opening 10 or the third opening 30, simply by rotating the entire body of the device by 180°.

This can be useful based on the position of the return pipe of the system (to which the device inlet is to be connected) and of the pipe leading back into the boiler (to which the device outlet is to be connected), in particular when operating in the fourth configuration. In such a case, for example, based on the distance of the pipe delivering into the boiler from the wall of installation, it may be useful to select either the first or the third inlet opening as the fluid outlet of the device.

In general, irrespective of the operative configuration selected, the device 1 is usually directly supported by the two lines of the system on which it is installed (or on which the openings acting as inlet and outlet are installed).

The method for filtering a fluid circulating in a plumbing and heating system according to the present invention preferably corresponds to the operating mode of the device 1. Essentially, the method comprises:
arranging a device 1, preferably according to what has been described;
identifying a line coming from the plumbing and heating system, particularly a heating water return line from a system of heating elements, carrying a flow of water to be subjected to filtration;
identifying a line directed to a boiler of the plumbing and heating system, this line carrying a flow of water that has undergone filtration;
operating the device selectively in one of the aforesaid operative configurations.

The invention thus conceived is susceptible of numerous modifications and variants, all falling within the scope of the inventive concept, and the components mentioned may be replaced by other technically equivalent elements.

The invention achieves important advantages. First of all, as emerges clearly from the above description, the invention enables at least some of the drawbacks of the prior art to be overcome.

The device of the present invention enables an effective filtration of a fluid circulating in a plumbing and heating system, and achieving it in every operative configuration. In particular, irrespective of which opening acts as an inlet and which as an outlet, the filtration of the fluid is always optimal. In fact, as amply described above and illustrated in the figure, in every operative configuration the entire flow of fluid effectively undergoes both mechanical filtration and magnetic filtration, without any portion of fluid passing through the device without being fully filtered, as occurs by contrast in the prior art solutions. Therefore, the device of the present invention combines versatility of use, as three inlet/outlet openings are available, and the possibility of deciding which one will act as an inlet for the fluid and which one as an outlet, with maximum efficiency in terms of filtration in every operative configuration.

This allows the device to be adapted to a large number and different types of boilers or other components of a heating system and to be able to be installed even in very limited spaces, while at the same time effectively performing the required filtering operations. In short, the device of the present invention is capable of operating with consistent high performances irrespective of the mode of installation inside a plumbing and heating system

This is made possible, in particular, thanks to the conformation and positioning of the filtering septum, which enables the two half-chambers to be defined and the fluid to be directed in such a manner that it always (i.e. in every operative configuration) passes through the mechanical filter (i.e. the filtering septum) and by the magnetic filter (or magnetic filters if two are present): this makes the filtration always optimal, overcoming the problems of the prior art.

The path of the fluid in the filtration chamber, always first through one half-chamber and then through the other, always enables an effective double filtration to be obtained. The filtering septum is in fact designed to handle all four different configurations: once the inlet opening and outlet opening have been chosen (and the remaining opening closed), the device is already ready to operate, without there being any need to modify the position of the elements of the device. In particular, the filtering septum enables the operation of the device in the different configurations without needing to be moved or repositioned.

Furthermore, the device of the present invention is characterised by high operating reliability and a lower predisposition to faults and malfunctions and it can be assembled, disassembled, cleaned and maintained in a simple and rapid manner.

Finally, the device of the present invention is characterised by a competitive cost and a simple, rational structure.
This listing of claims will replace all prior versions and listings of claims in the application:

1. A device (1) for filtering a fluid circulating in a plumbing and heating system, said device (1) comprising a body (2) of the device which defines therewithin a filtration chamber (3) that is destined to have a fluid to be subjected to filtration pass through it, said body being provided with:
a first inlet/outlet opening (10), which sets said filtration chamber (3) in communication with the outside of the device and that is configured to be associated with a line so as to receive therefrom, or to send thereto, fluid entering, or exiting from, said body of the device;
a second inlet/outlet opening (20), which sets said filtration chamber (3) in communication with the outside of the device and that is configured to be associated with a respective line so as to receive therefrom, or to send thereto, fluid incoming to, or exiting from, said body of the device;
a third inlet/outlet opening (30), which sets said filtration chamber (3) in communication with the outside of the device and that is configured to be associated with a respective line so as to receive therefrom, or to send thereto, fluid incoming to, or exiting from, said body of the device;
the device being configured to bring about a passage of fluid through said filtration chamber (3), in a selective manner according to a plurality of operative configurations, from one opening among said first inlet/outlet opening (10), said second inlet/outlet opening (20), and said third inlet/outlet opening (30) to another opening among said first inlet/outlet opening (10), said second inlet/outlet opening (20), and said third inlet/outlet opening (30),
the device further comprising filtering members (40) that are at least partially housed inside said filtration chamber (3), or associated with said body (2) of the device, and operatively interposed between said first inlet/outlet opening, said second inlet/outlet opening and said third inlet/outlet opening to carry out filtering of the fluid passing through the filtration chamber;
wherein said filtering members (40) comprise at least one filtering septum (41) configureds to perform a mechanical separation of substances and solid particles present in the fluid to be treated from the fluid in which they are suspended, said filtering septum (41) being arranged inside said filtration chamber (3) so as to subdivide the filtration chamber into a first half-chamber (8) and a second half-chamber (9), wherein:
the first half-chamber (8) is in fluid communication with the first inlet/outlet opening, without passage through the filtering septum;
the second half-chamber (9) is in fluid communication with the second inlet/outlet opening and with the third inlet/outlet opening, without passage through the filtering septum;
in such a manner that in each one of said plurality of operative configurations, to pass from said first half chamber (8) to said second half-chamber (9), or vice versa, the fluid transiting in the filtration chamber (3) passes through said filtering septum (41).

2. The device (1) according to claim 1, wherein the passage between the first half-chamber (8) and the second half-chamber (9) necessarily takes place through the filtering septum (41), and/or wherein the first half-chamber (8) and the second half-chamber (9) are connected with each other only through the filtering septum (41), and/or wherein the filtering septum (41) has, at least in one portion thereof, a structure provided with a plurality of passages (42) that have a given filtering section, so that the passage of the fluid from a first side (43) of the filtering septum to a second side (44) of the filtering septum determines retention, on the first side (43), of the substances and particles present in the fluid and having dimensions greater than said filtering section, and vice versa the passage of the fluid from the second side (44) to the first side (43) determines retention, on the second side (44), of the substances and particles present in the fluid and having dimensions greater than said filtering section, and/or wherein the filtering septum (41) has the form of a thin sheet or membrane that extends longitudinally over a plane of extension (45) between an upper end (46) and a lower end (47).

3. The device (1) according to claim 1, wherein the filtering septum (41) is positioned in the filtration chamber (3) in such a manner that the first side (43) thereof faces the first inlet/outlet opening and the second side (44) thereof faces the third inlet/outlet opening (30) and/or the second inlet/outlet opening (20), and/or wherein the filtering septum (41) is configured to operate in a single position for use which is maintained for each one of said plurality of operative configurations taken on by the device, in which:
it prevents the fluid from passing directly from the first opening (10) to the second opening (20) or from the first opening (10) to the third opening (30), without passing through the filtering septum;
it prevents direct passage of the fluid from the second opening (20) to the first opening (10) or from the third opening (30) to the first opening (10) without passing through the filtering septum;
and/or wherein the filtering septum (41) is configured to operate in a single position for use, which is maintained for each one of said plurality of operative configurations taken on by the device, in which:
passage of the fluid from the first opening (10) to the second opening (20) or from the first opening (10) to the third opening (30) takes place by passage through the filtering septum;
passage of the fluid from the second opening (20) to the first opening (10) or from the third opening (30) to the first opening (10) takes place by passing through the filtering septum.

4. The device (1) according to claim 1, comprising a closure element (4) that is configured to selectively intercept one opening among said first inlet/outlet opening (10), said second inlet/outlet opening (20), and said third inlet/outlet opening (30), and wherein said plurality of operative configurations comprise at least:
a first operative configuration, in which said first opening (10) receives a flow of fluid incoming to the device, said second opening (20) sends the flow of filtered fluid exiting from the device and said third opening (30) is intercepted by said closure element (4);
a second operative configuration, in which said first opening (10) receives a flow of fluid incoming to the device, said third opening (30) sends the flow of filtered fluid exiting from the device and said second opening (20) is intercepted by said closure element (4);
a third operative configuration, in which said third opening (30) receives a flow of fluid incoming to the device, said first opening (10) sends the flow of filtered fluid exiting from the device and said second opening (20) is intercepted by said closure element (4);
a fourth operative configuration, in which said second opening (20) receives a flow of fluid incoming to the device, said first opening (10) sends the flow of filtered fluid exiting from the device and said third opening (30) is intercepted by said closure element (4),
and/or wherein said operative configurations provide for passage of the fluid through the filtering septum (41), from the first side (43) to the second side (44), when the fluid enters the device from the first inlet/outlet opening (10) and leaves the device from the second inlet/outlet opening (20) or from the third inlet/outlet opening (30), and/or wherein said operative configurations provide for passage of the fluid through the filtering septum (41), from the second side (44) to the first side (43), when the fluid enters the device from the second inlet/outlet opening (20) or from the third inlet/outlet opening (30) and leaves the device from the first inlet/outlet opening (10).

5. The device (1) according to claim 1, wherein the filtration chamber is delimited laterally by a lateral surface (3A), above by a top surface (3B) and below by a bottom surface (3C) of the body (2) of the device, and wherein the filtering septum is positioned longitudinally between the bottom surface (3C) and the top surface (3B) of the filtration chamber of the body (2) of the device, and/or wherein the filtering septum has two prevalent dimensions, on said plane of extension (45), and a third smaller dimension, perpendicularly to said plane of extension, wherein said two prevalent dimensions are a height of the filtering septum along a direction coinciding with an axis of longitudinal extension (2A) of the body (2) and a width of the filtering septum along a direction perpendicular to the axis of longitudinal extension (2A) of the body (2), and wherein said height of the filtering septum substantially corresponds to the distance between the top surface (3B) and the bottom surface (3C) of the filtration chamber (3), so that at the top and bottom the septum is in contact with the surfaces of the filtration chamber (3), and wherein said width of the filtering septum corresponds to a radial dimension of the filtration chamber (3), so that it is in contact with the lateral surface (3A) of the filtration chamber (3).

6. The device (1) according to claim 1, wherein the body (2) of the device is provided with a dividing wall (21) extending inside the filtration chamber (3) between the upper end (46) of the filtering septum and a point of the top surface interposed between the first inlet/outlet opening (10) and the second inlet/outlet opening (20), and wherein the dividing wall (21) extends continuously with respect to the filtering septum (41), and together with the latter, it contributes to dividing the filtration chamber longitudinally into the first half-chamber and the second half-chamber, and/or wherein the dividing wall (21) lies at least partially on the plane of extension of the filtering septum and/or on the axis of longitudinal extension (2A) of the body of the device, and/or wherein starting from one side of the second inlet/outlet opening (20), said side facing the first inlet/outlet opening (10), the dividing wall (21) extends, inside the filtration chamber (3) according to a direction substantially consistent with the axis of longitudinal extension (2A) of the body of the device and substantially to a height (Q) coinciding with the dimensions of the first inlet/outlet opening (10) on the external lateral surface (6) of the body (2) of the device and/or with the dimensions of the third inlet/outlet opening (30) on the external lateral surface (6) of the body (2) of the device, and/or wherein the filtering septum is positioned longitudinally between the bottom surface (3C) of the body (2) of the device and the dividing wall (21).

7. The device (1) according to claim 1, wherein the filtering members (40) comprise at least a first magnetic filter (50) associated with the body (2) of the device and configured to collect and retain substances and particles having ferromagnetic properties and that are present in the fluid to be treated, in such a manner as to separate them from the fluid passing through the device, and wherein the body (2) of the device comprises at least a first hollow protuberance (51) that emerges axially, in the filtration chamber, from said bottom surface (3C) towards said top surface (3C), said first hollow protuberance (51) defining, outside the body (2) of the device, a first housing (52) that is elongated in shape, corresponding to the first hollow protuberance (51) and accessible from the lower surface (7), said first housing (52) accommodating the first magnetic filter (50), and/or wherein said first hollow protuberance (51) emerges axially inside said second half-chamber or, alternatively, inside said first half-chamber, and/or wherein the first magnetic filter (50) comprises at least a first magnetic element (53) that is configured to generate a permanent magnetic field and inserted in said first housing (52) of the body (2) in such a manner as to act upon the fluid passing through the filtration chamber (3) and retain the ferromagnetic substances and particles present in the fluid on the surface of said first hollow protuberance (51) inside the body of the device.

8. The device (1) according to claim 1, said device (1) being configured to operate selectively, when in use, in one of the following operative configurations:—a first operative configuration, in which:
the first inlet/outlet opening (10) is destined to be set into communication with a line coming from a plumbing and heating system, particularly a hot water return line from a system of heating elements, so as to receive a flow of water to be subjected to filtration;
the second inlet/outlet opening (20) is destined to be set into communication with a line directed to a boiler of the plumbing and heating system, so as to send thereto the flow of water following filtration;
the third inlet/outlet opening (30) is intercepted by a closure element (4);
the flow of fluid incoming to the first opening (10) flows into the first half-chamber (8) and is necessarily directed so as to pass through the filtering septum (41) from the first side (43), undergoing mechanical filtration and leaving from the second side (44) so as to flow into the second half-chamber (9);
the fluid travels through the second half-chamber (9) where it undergoes magnetic filtration by the first magnetic filter (50);
the fluid is conveyed towards the second inlet/outlet opening (20), the third inlet/outlet opening (30) being intercepted;
a second operative configuration, in which:
the first inlet/outlet opening (10) is destined to be set into communication with a line coming from a plumbing and heating system, particularly a hot water return line from a system of heating elements, so as to receive a flow of water to be subjected to filtration;
the second inlet/outlet opening (20) is intercepted by a closure element (4);
the third inlet/outlet opening (30) is destined to be set into communication with a line directed to a boiler of the plumbing and heating system, so as to send thereto the flow of water following filtration;
the flow of fluid incoming to the first opening (10) flows into the first half-chamber (8) and is necessarily directed so as to pass through the filtering septum (41) from the first side (43), undergoing mechanical filtration and leaving from the second side (44) so as to flow into the second half-chamber (9);
the fluid travels through the second half-chamber (9) where it undergoes magnetic filtration by the first magnetic filter (50);
the fluid is conveyed towards the third inlet/outlet opening (30), the second inlet/outlet opening (20) being intercepted;
a third operative configuration, in which:
the third inlet/outlet opening (30) is destined to be set into communication with a line coming from a plumbing and heating system, particularly a hot water return line from a system of heating elements, so as to receive a flow of water to be subjected to filtration;
the second inlet/outlet opening (20) is intercepted by a closure element (4);
the first inlet/outlet opening (10) is destined to be set into communication with a line directed to a boiler of the plumbing and heating system, so as to send thereto the flow of water following filtration;
the flow of fluid incoming to the third opening (30) flows into the second half-chamber (9) where it undergoes magnetic filtration by the first magnetic filter (50) and as the second inlet/outlet opening (20) is intercepted, it is thus necessarily directed so as to pass through the filtering septum (41) from the second side (44), undergoing mechanical filtration and leaving from the first side (43) so as to flow into the first half-chamber (8);
the fluid travels through the first half-chamber (8) and is conveyed towards the first inlet/outlet opening (10);
a fourth operative configuration, in which:
the second inlet/outlet opening (20) is destined to be set into communication with a line coming from a plumbing and heating system, particularly a hot water return line from a system of heating elements, so as to receive a flow of water to be subjected to filtration;
the third inlet/outlet opening (30) is intercepted by a closure element (4);
the first inlet/outlet opening (10) is destined to be set into communication with a line directed to a boiler of the plumbing and heating system, so as to send thereto the flow of water following filtration;
the flow of fluid incoming to the second inlet/outlet opening (20) flows into the second half-chamber (9) where it undergoes magnetic filtration by the first magnetic filter (50) and as the third inlet/outlet opening (30) is intercepted, it is thus necessarily directed so as to pass through the filtering septum (41) from the second side (44), undergoing mechanical filtration and leaving from the first side (43) so as to flow into the first half chamber (8);
the fluid travels through the first half-chamber (8) and is conveyed towards the first inlet/outlet opening (10).

9. The device (1) according to claim 7, wherein the body (2) of the device comprises a second hollow protuberance (81) that emerges axially, in the filtration chamber (3), from said bottom surface (3C) towards said top surface (3B), said second hollow protuberance (81) defining, outside the body (2) of the device, a
second housing (82) that is elongated in shape, corresponding to the second hollow protuberance (51) and accessible from the lower surface (7), and/or wherein said second hollow protuberance (81) emerges axially inside the half-chamber, between the first (8) and the second half-chamber (9) not occupied by the first hollow protuberance (51), or wherein said second hollow protuberance (81) emerges axially inside said first half chamber (8), whereas said first hollow protuberance (51) emerges axially inside said second half-chamber (9), and/or wherein said first magnetic filter (50) can be selectively housed in the first hollow protuberance (51) or in the second hollow protuberance (81) of the body (2) of the device, according to the operative configuration selected.

10. The device (1) according to claim 9, wherein the filtering members (40) comprise a second magnetic filter (80) associated with the body (2) of the device and configured to collect and retain substances and particles having ferromagnetic properties and that are present in the fluid to be treated, in such a manner as to separate them from the fluid passing through the device, and/or wherein said second magnetic filter (80) is structurally identical to said first magnetic filter (50), and/or wherein said second magnetic filter (80) comprises at least a second magnetic element (83) that is configured to generate a permanent magnetic field and inserted in said second housing of the body (2) in such a manner as to act upon the fluid passing through the filtration chamber (3) and retain the ferromagnetic substances and particles present in the fluid on the surface of said second hollow protuberance (81) inside the body of the device, and wherein said second magnetic filter (80) is housed in said second housing (82).

11. The device (1) according to claim 1, further comprising a drain cock (90) configured to enable the filtration chamber (3) to be emptied without disassembling the device from the system in which it is installed, without disconnecting the first, second, and third inlet/outlet openings from the respective lines, and without disassembling the body (2) of the device, wherein the drain cock (90) is positioned at a drain opening (91) located on the bottom surface (3C) of the body (2) straddling the lower end (47) of the filtering septum (41) in such a manner as to be in communication with the first half-chamber (8) and with the second half chamber (9), without putting the first and the second half-chamber in communication with each other, and/or wherein the drain opening (91) is located at the lower end of an inclined portion (90) of the bottom surface (3C), extending downwards, that is, away from the top surface (3B), with respect to the rest of the bottom surface, said inclined portion (92) enabling the material filtered inside the filtration chamber, particularly by the filtering septum, to be conveyed towards the drain opening (91) by gravity or settling, and/or wherein the drain cock (90) can be operated selectively in a closed state, in which the drain opening (91) is intercepted and does not allow the fluid to leave the filtration chamber (3), or an open state, in which the drain opening (91) is set in communication with the outside of the device.

12. A method for filtering a fluid circulating in a plumbing and heating system, said method comprising the steps of:
arranging at least one device (1) for filtering a fluid according to claim 1;
identifying a line coming from a plumbing and heating system, particularly a hot water return line from a system of heating elements, carrying a flow of water to be subjected to filtration;
identifying a line directed to a boiler of the plumbing and heating system, this line carrying a flow of water that has undergone filtration to the boiler;
operating the device (1) selectively in one of said operative configurations.
